(19) United States
(12) Patent Application Publication
(10) Pub. No.: US 2026/0178145 A1
(43) Pub. Date: Jun. 25, 2026

(54) TOUCH SCREEN CONTROL DEVICE AND METHOD

(71) Applicant: Pro-Tech Inlab, Limited Liability Company, Russian Federation, Moscow (RU)

(72) Inventor: Andrey Alekseevich PROVKIN, Moscow (RU)

(21) Appl. No.: 18/728,901

(22) PCT Filed: Sep. 14, 2023
(86) PCT No.: PCT/RU2023/000271

§ 371 Date: Jul. 15, 2024

(30) Foreign Application Priority Data
Aug. 25, 2023 (RU) 2023122132

(51) Int. Cl. G06F 3/041; G06F 3/044

(52) U.S. Cl. CPC G06F 3/04166; G06F 3/0416; G06F 3/0445; G06F 3/0446

(57) ABSTRACT

The invention relates to the field of electronics and can be used in devices intended for testing touch screens and devices that transmit information through a touch screen. A touch screen control device consisting of a control unit installed on a printed circuit board, a harmonic oscillator amplifier with positive feedback through a feedback circuit and a coplanar capacitor containing two plates, with one plate of the capacitor connected closer to the input of the amplifier and the other plate closer to the output of the amplifier, wherein the capacitor plates are located in the same plane. The technical result is simplification of the device, increased stability and reliability of operation, and compactness. 2 independent claims, 12 dependent claims, 11 illustrations.

### FIELD OF THE INVENTION

The invention relates to the field of electronics and can be used in devices intended for testing touch screens and devices that transmit information through a touch screen.

### PRIOR ART

The prior art includes methods used to control touch screens with devices, which are used to test the hardware of screens, as well as to model the behavior of users interacting with the screen interface (see https://www.prorobot.ru/17/quality-commander.php, 28.12.2010; https://androidinsider.ru/polezno-znat/kak-testiruyutsya-sensornyie-displei.html, Dec. 22, 2013).

For example, various robotic devices, including hands with “fingers” equipped at the ends with conductive pads, can be used as technical means to simulate physical touch of the screen (see CN201138361Y, Oct. 22, 2008; CN203133768U, Aug. 14, 2013). In other cases, simpler electro-mechanical drives may be used. The devices are grounded; when the screen is touched, they trigger the screen sensors and register the events when the screen is touched by the screen hardware and software systems. In addition to testing the technical part to assess the accuracy and responsiveness of the screens, the robot can be used to simulate various levels of skills of users of touch screens: during games, typing, etc. Technical means that simulate touch can also be used to transmit information through touch screens.

The disadvantages of the solutions mentioned above include their inertia, the complexity of the design containing a large number of moving parts, unstable and unreliable operation of the devices leading to false activation of the screen, as well as their large dimensions.

### DISCLOSURE OF THE INVENTION

The technical task is to create a simple and portable touch screen control device without moving parts, characterized by stable and reliable operation.

The technical result is simplification of the device, increased stability and reliability of operation, and compactness.

The technical result is achieved with a touch screen control device that contains a control unit installed on a printed circuit board, a harmonic oscillator amplifier with positive feedback through a feedback circuit and a coplanar capacitor containing two plates, with one plate of the capacitor connected closer to the input of the amplifier and the other plate closer to the output of the amplifier, wherein the capacitor plates are located in the same plane.

In addition, the capacitor is designed to be applied to the touch screen in parallel or perpendicular or in intermediate positions, adjacent or at a distance not exceeding 1 mm from the surface of the touch screen.

In addition, the capacitor has a base that is made of a dielectric material and is either inseparable from the device board or made as a separate element.

In addition, the dimensions of the coplanar capacitor plates are selected in such a way that the distance between their geometric centers coincides with the distance between the centers of the touch screen sensors.

In addition, the capacitor plates have connectors with the feedback circuit; the length of the connectors is not more than 2 mm.

In addition, the harmonic oscillator amplifier is assembled in three transistor stages in a common emitter amplifier circuit.

In addition, the harmonic oscillator amplifier is built according to a non-inverting configuration with a zero phase shift at the self-oscillation frequency in the feedback circuit.

In addition, the harmonic oscillator amplifier is built according to an inverting configuration at the self-oscillation frequency with a 180-degree phase shift feedback circuit.

In addition, the harmonic oscillator amplifier is built according to an inverting configuration, but with a 180-degree phase shift at the self-oscillation frequency with a zero phase shift feedback circuit, or a 360-degree phase shift when combined with the shift of the amplifier multiple times.

The method to control the touch screen using the control device consists of the following steps:
the voltage is supplied from the control unit to the oscillator amplifier of the control device, forming an electromagnetic field between the plates of the coplanar capacitor located in the same plane;
when harmonic voltage fluctuations occur on the plates of the capacitor located in the same plane, the touch screen is affected by applying the capacitor to the sensors of the touch screen in parallel or perpendicular or in intermediate positions, adjacent or at a distance from the surface of the touch screen, where the variable electromagnetic field formed in the self-oscillation mode of the amplifier affects the fields formed by the sensors of the touch screen, increasing or decreasing their capacitance depending on the operating mode of the touch screen controller;
the touch screen controller is used to determine the change in the capacitances of the touch screen sensors relative to the pre-established rest level, and touch screen events at a point located inside, or at the minimum distance from, the area of projection on the screen of the capacitor plates are registered.

In addition, the touch screen is affected with harmonic voltage fluctuations of medium frequency (1-2 MHz) on the plates of the capacitor located in the same plane.

In addition, the touch screen is affected by applying the capacitor to the sensors of the touch screen at a distance not exceeding 1 mm from the surface of the screen.

In addition, the coordinates of the touch event registration points are located within an area with a radius of 10 mm, with the center lying within the projection of the coplanar capacitor.

In addition, the dimensions of the plates of the coplanar capacitor are selected in such a way that the distance between their geometric centers coincides with the distance between the centers of the screen sensors.

### BRIEF DESCRIPTION OF THE DRAWINGS

FIG. 1—Touch screen control device;

FIG. 2—Coplanar capacitor (side view);

FIG. 3—Coplanar capacitor (top view);

FIG. 4—Distribution of electric fields of the coplanar capacitor and the touch screen located parallel to each other;

FIG. 5—Distribution of electric fields of the coplanar capacitor and the touch screen located perpendicular to each other;

FIG. 6—Electric field of the mutual-capacitive touch screen prior to interaction with the field of the coplanar capacitor;

FIG. 7—Interaction of the electric fields of the coplanar capacitor and the mutual-capacitive touch screen;

FIG. 8—Electric field of the self-capacitive touch screen prior to interaction with the field of the coplanar capacitor;

FIG. 9—Interaction of the electric fields of the coplanar capacitor and the self-capacitive touch screen;

FIG. 10—Oscillogram of harmonic oscillations on the plates of the coplanar capacitor;

FIG. 11—Oscillogram of oscillations on the plates of the coplanar capacitor; corresponding to a single touch screen event.

### NUMBERS IN THE FIGURES INDICATE THE FOLLOWING ITEMS

1—electrical signal amplifier;
2—feedback circuit;
3—base of the coplanar capacitor;
4—plate of the coplanar capacitor;
5—plate of the coplanar capacitor;
6—control unit;
7—area between the plates;
8—electric field line between the plates of the coplanar capacitor;
9—touch screen base;
10—screen sensor (sensing electrode);
11—screen sensor (driving electrode);
12—driver of the screen sensor (driving electrode);
13—electric field line of the mutual-capacitance of the screen sensors;
14—electric field line between the coplanar capacitor plate located closer to the amplifier output and the screen sensor (sensing electrode);
15—electric field line between the coplanar capacitor plate located closer to the amplifier input and the screen sensor (sensing electrode);
16—electric field line between the coplanar capacitor plate located closer to the amplifier output and the screen sensor (driving electrode);
17—electric field line between the coplanar capacitor plate located closer to the amplifier input and the screen sensor (driving electrode);
18—electric field line of the self-capacitance of the screen sensor (driving electrode);
19—electric field line of the self-capacitance of the screen sensor (sensing electrode).

### EMBODIMENT OF THE INVENTION

The created technical solution is a portable electronic device that can trigger the registration of touch events when the touch screen is affected. The device contains no moving parts, microelectromechanical or other, and is assembled on a printed circuit board with a size not exceeding 2 sq. cm. The coordinates of the touch event registration points are located within an area with a radius of 10 mm, with the center lying within the projection of the device element (coplanar capacitor) designed to directly affect the touch screen. The device is designed to be powered by a battery (accumulator). The touch screen is affected with harmonic voltage fluctuations of medium frequency (1-2 MHz) on the plates of the capacitor located in the same plane. The capacitor is applied to the screen in parallel or perpendicular (or may be in intermediate positions), adjacent or at a distance not exceeding 1 mm from the screen surface.

The touch screen control device is based on a medium frequency harmonic oscillator. The occillator is essentially an amplifier with positive feedback, and the feedback circuit contains a coplanar capacitor with plates located in the same plane, which is adjacent to the screen surface. Due to the open plates, the variable electromagnetic field generated in the self-oscillation mode of the amplifier affects the fields formed by the screen sensors, increasing or decreasing their capacitance (depending on the operating mode of the screen controller). The screen controller detects changes in the sensor capacitances relative to the preset “rest” level and registers touch events. The oscillator is powered by the device control unit, which can be set to generate both relatively slow (constant) “taps” and values limited by the capacity of a particular screen (e.g., 30 Hz). The control unit can also transmit a signal to the device with the touch screen in the form of a digital code, for example, by means of amplitude manipulation.

Projection-capacitive touch screens consist of two mutually perpendicular groups of transparent sensor electrodes separated by a dielectric layer. There are two main processes by which such screens work. In one case, the screen controller sends sequential electrical signals to the sensors of the first group, and an electric field occurs at the intersection with the sensors of the second group. The screen controller measures the mutual-capacitance of the sensors characterized by this field. When the user touches the touch screen with a finger, the charge on the sensor of the second group decreases due to the capacitance of the user's body, and the mutual-capacitance of the sensors also decreases. In the second case, the controller can measure the self-capacitance of each sensor in both groups. In case of a touch, their capacitance will increase. The screen controller detects changes in the capacitance of the sensors and registers the touch at their intersection. There are touch screens that can use both operation modes.

The technical solution examples described here allow control of the touch screen using a capacitor with coplanar (located in the same plane) plates. The electromagnetic field of the coplanar capacitor, being located in close proximity to the surface of the touch screen, affects the field of nearby screen sensors and causes it to be registered by the touch event controller.

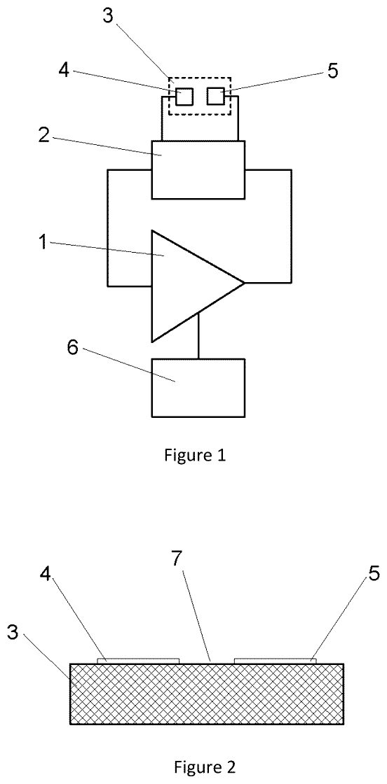

FIG. 1 shows the device used to control the touch screen. The electronic circuit is a controlled RC oscillator. The amplifier (1) has positive feedback by means of a feedback circuit (2) and a coplanar capacitor (3) with an air dielectric. One plate of the capacitor (4) is connected closer to the amplifier input (1), the other plate (5) is connected closer to the amplifier output (1). When the voltage is supplied from the control unit (6), the amplifier (1) is oscillated, and an electromagnetic field occurs between the plates of the coplanar capacitor (3), which interacts with the sensors of the touch screen, the controller of which registers the touch event at a point located inside, or at the minimum distance from, the projection on the screen of the plates (4, 5) of the capacitor (3). The device is portable and its electronic circuit requires a battery. A variable electromagnetic field between the plates of the coplanar capacitor (3) induces a floating voltage. In this case, a floating ground is induced on the plate (4) located closer to the input of the amplifier (1). The mobile device with the touch screen also induces a floating ground and determines the capacitance of the screen sensors relative to it.

The amplifier (1) can be constructed, for example, according to a non-inverting configuration with a zero phase shift at the self-oscillation frequency in the feedback circuit (2), which includes the coplanar capacitor (3). In another case, the amplifier (1) can be built according to an inverting configuration at the self-oscillation frequency with a 180-degree phase shift feedback circuit (2), which includes the coplanar capacitor (3). Also, the amplifier (1) can be built according to an inverting configuration, but with a 180-degree phase shift at the self-oscillation frequency, with a feedback circuit (2) including the coplanar capacitor (3), and with a zero phase shift (or a 360-degree phase shift when combined with the shift of the amplifier (1) multiple times).

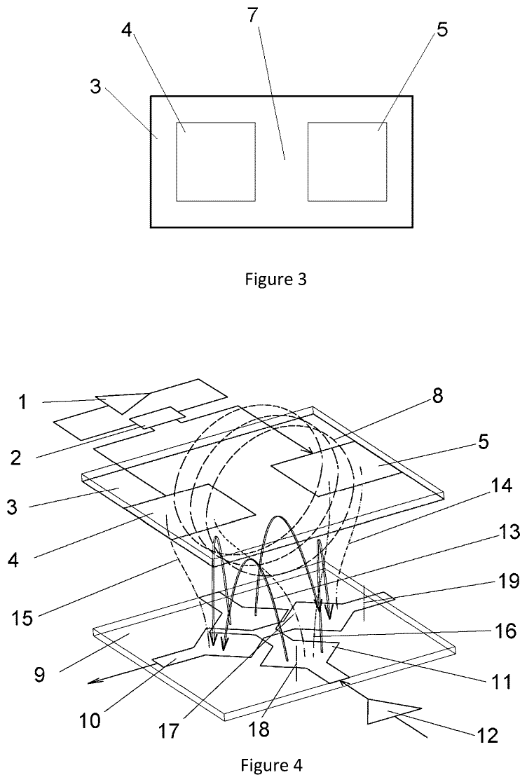

FIG. 2 and FIG. 3 show the coplanar capacitor in more detail. Its base (3) can be made of a dielectric material, for example, fiberglass or a different material. It can be either inseparable from the device board or made as a separate element. The plates (4 and 5) can be etched, glued, or formed in another way.

A typical touch screen contains a matrix of sensors arranged in the form of a diamond grid, with the dimension of the diamond diagonals being equal or close to 4 mm. The dimensions of the plates (electrodes) of the coplanar capacitor are selected in such a way that the distance between their geometric centers mostly coincides with the distance between the centers of the screen sensors (in this case, for example, 4 mm) or is as close to the latter as possible, with an error of 1-2 mm. FIG. 3 provides a top view of the coplanar capacitor. If the selected lengths of the sides of the plates (4 and 5) are 2 mm and the distance between them (7) is 2 mm, the distance between the centers of the plates is 4 mm. The capacitance of a coplanar capacitor is mostly parasitic capacitance due to the influence of the edge effect (an increase in the electric field strength at the edges of the plates). It is difficult to accurately calculate this capacitance due to the need to take into account the degree of penetration of the electric field into the base of the capacitor (3) and into the air or protective coating of the capacitor. Relatively complex formulas are known, but for the implementation being presented, it is sufficient to use the following formula:

$$C = {ε}_{c} β \vert = 2.7 \times 1.3 \times 0.2 = 0.7 pF$$

where:
β is an empirical coefficient that depends on the width of the plates and the distance between them; the accepted value is used in the case of equality of the sides of the plates (FIG. 3, Item 4 and Item 5) and the distance between them—the area (FIG. 3, Item 7);
I is the length of the joint border of the plates (FIG. 3, Item 4 and Item 5) along the area (FIG. 3, Item 7), cm;
ε_{c} is the calculated relative permittivity: for a capacitor without a protective coating,

$${ε}_{c} ( 1 + {ε}_{c} ) / 2 = ( 1 + 4.4 ) / 2 = 2.7$$

(for a capacitor coated with a protective layer, εᵣ=(εₛ+ε_{coat})/2),
where εₛ is the relative permittivity of the substrate material (FR4 fiberglass);
ε_{coat} is the relative permittivity of the protective coating.

In the present implementation according to FIG. 1, the amplifier (1) is assembled in three transistor stages in a common emitter amplifier circuit. The coplanar capacitor (3) is connected to the input and output matching components of the feedback circuit (2), which is characterized by a zero phase shift. Phase balance is known to be a condition for the self-oscillation of the RC oscillator:

$${φ}_{amp} + {φ}_{fb} = 2 π n ,$$

where:
φₐₘₚ is the phase shift at the amplifier output;
φ_{ib} is the phase shift of the feedback circuit;
n is an integer.

Each stage of an amplifier of this type is characterized by a 180-degree phase shift, subject to the presence of low frequency harmonic oscillations at the input. But, with a coplanar capacitor (3) of a rather small capacitance of 0.7 pF, the frequency of self-oscillation of the amplifier in this implementation is 1.8 MHz, which corresponds to the typical level of the phase-frequency characteristic of the used bipolar transistors at this frequency, 60 degrees per stage. Thus, the n value of the phase balance is 2. The stable performance of the device disclosed here at a power supply voltage of ±25 V, which is maintained when the level is reduced to ±12 V (when the plates are parallel to the surface of the screen), has been established in experiments.

By introducing additional circuits into the amplifier, the range of self-oscillation frequencies of the amplifier, at which the device solves the technical task, from 600 kHz to 2.3 MHz, was established in the experiments (at a lower frequency, the effect on the touch screens disappears; no experiments were carried out at a higher frequency). For a preliminary illustration of this effect, FIG. 4 and FIG. 5 show the options for the relative location of the coplanar capacitor and two screen sensors without taking into account the interaction. In this case, it can be assumed that the moment before the interaction begins is shown and the most important electric field lines are shown (one for each pair of charged plates/sensors). In reality, the location of the capacitor relative to the sensors may be different (with the parallel placement shown in FIG. 4, the perpendicular placement shown in FIG. 5, as well as with intermediate placements). The capacitor also interacts with the sensors located next to the ones shown (in the adjacent cells of the screen grid), but to a lesser extent. When the coplanar capacitor is moved away from the pair of sensors shown along the screen plane, it will interact to a greater extent with the other sensors, but the principle of their interaction will be the same as the one described. The electromagnetic field between the plates of the coplanar capacitor (8) is considered to be quasi-stationary. Vortex fields formed by high-frequency oscillations of the oscillator are not shown, but have an additional effect on the screen sensors, under the influence of the coplanar capacitor discussed below. In the case of the position perpendicular to the screen (FIG. 5), the power lines (8) will affect the screen sensors due to the edge effect. The sensors are located in different planes at the base of the screen (9), wherein the sensor (10) is a sensing electrode that is usually higher, and the sensor (11) is a driving electrode usually located lower. The driver of the sensor (12) sends an electrical signal to the sensor (11) in the mutual-capacitive sensing mode. As a result, field lines are formed (13). A field line (14) is formed between the plate (5) located closer to the amplifier output (1) after the feedback circuit (2) and the sensor (10). Similarly, the plate (4) is associated with the field line (15). Field lines are also formed between the plates and the sensors: the line (16) between the plate (5) and the sensor (11) and the line (17) between the plate (4) and the sensor (11), respectively. The lines of the sensor (18) and the sensor (19) are involved in the self-capacitive sensing mode.

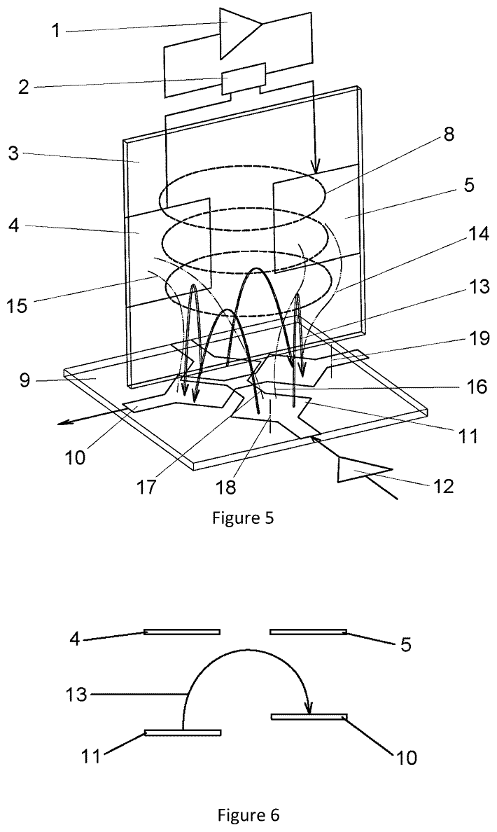

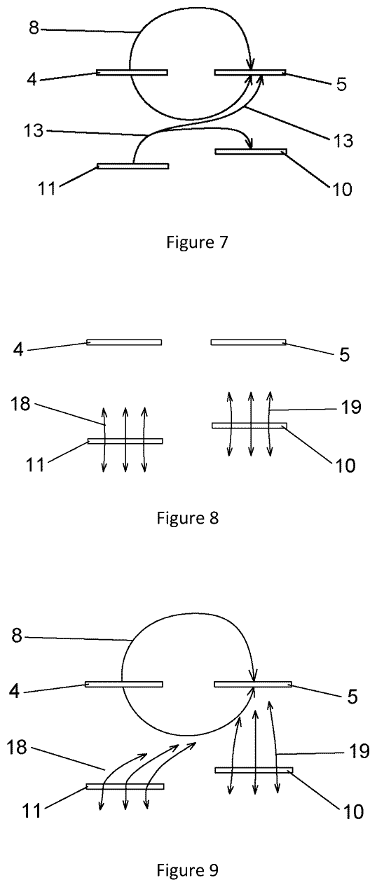

Below is a discussion of some of the lines involved in the registration of touch screen events in the mutual-capacitive sensing mode. FIG. 6 shows the plates of the coplanar capacitor (4, 5), sensors (11, 10) and power line (13) between them before feeding power to the oscillator. In this case, the sensor (11) periodically charges the sensor (10), and the screen controller periodically measures their mutual-capacitance (usually by transferring the charge, i.e., by charging the sensor (10) using a reference capacitor and then discharging it). Some steady-state measured value is assumed to correspond to the absence of touch. FIG. 7 shows the interaction of the coplanar capacitor after power is supplied to the amplifier, self-oscillation occurs, and an electric field is generated on the plates (or after the capacitor is brought to the surface of the screen with the amplifier turned on in advance). In this case, the field lines of the capacitor (8) decrease the effect of the line (13) on the sensor (10), thus reducing the mutual-capacitance of the screen sensors. The screen controller registers the touch event. With oscillator self-oscillation half-periods corresponding to the opposite polarity of the lines (8), such an effect will not occur (the power lines 14-17 may be involved, as shown in FIG. 4 or FIG. 5). But in this case, it is highly likely that the same effect will be exerted on the adjacent power lines (FIG. 4, Item 13) and adjacent screen sensors. Reliable operation of the device using this method has been demonstrated both for the parallel placement relative to the screen (FIG. 4) and the perpendicular placement (FIG. 5). With the perpendicular placement, the sensors are less affected by the electronic circuit of the device, but the positioning has to be carried out more carefully. The effect of the electronic circuit with the parallel placement, which can lead to false activation of the screen, can be decreased, for example, by moving the plane of the device board from the base of the coplanar capacitor above the screen. In this case, it is not recommended to exceed the length of the connectors of the plates of the capacitor with the feedback circuit by more than 2 mm.

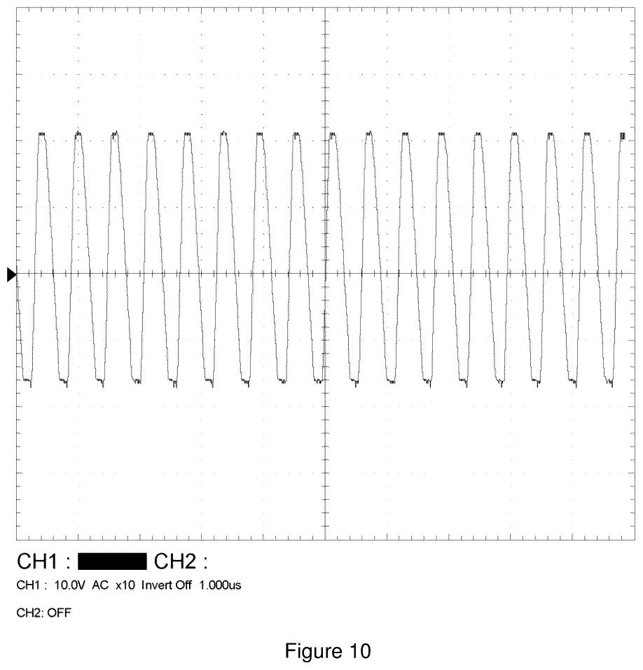

Below is a discussion of the interaction of the coplanar capacitor with the screen sensors during self-capacitive sensing. FIG. 8 shows the power lines (18 and 19) at rest (the amplifier is turned off, there is no voltage on the plates). FIG. 9 shows a change in the sensor power lines in case of an alternating field on the plates (4 and 5) of the coplanar capacitor. As shown by the Figures, the upper parts of the lines have lengthened, and this corresponds to an increase in the self-capacitance of the sensors. The screen controller registers the touch event.

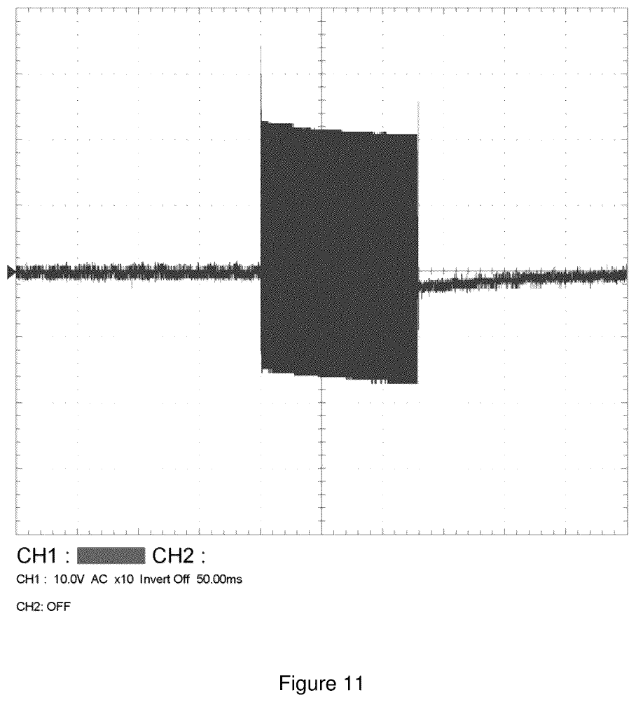

FIG. 10 shows a high-frequency oscillogram of harmonic oscillations on the plates of the coplanar capacitor. FIG. 11 shows an oscillogram of oscillations on the plates of the coplanar capacitor corresponding to one touch screen event. The slight vertical asymmetry of the signal is due to the presence of capacitors in the feedback circuit of the amplifier.

The device described here can also be used to transmit information to mobile devices via the touch screen, for example, by sending signals from the control unit (FIG. 1, Item 6), which turns on the amplifier (1) at certain time points. Thus, the signal on the plates of the coplanar capacitor is manipulated and messages (e.g., passwords) are transmitted. Messages may be received, for example, by a special mobile application.

1. A touch screen control device consisting of a control unit installed on a printed circuit board, a harmonic oscillator amplifier with positive feedback through a feedback circuit and a coplanar capacitor containing two plates, with one plate of the capacitor connected closer to the input of the amplifier and the other plate closer to the output of the amplifier, wherein the capacitor plates are located in the same plane.

2. The touch screen control device according to claim 1, wherein the capacitor is designed to be applied to the touch screen in parallel or perpendicular or in intermediate positions, adjacent or at a distance not exceeding 1 mm from the surface of the touch screen.

3. The touch screen control device according to claim 1, wherein the capacitor has a base that is made of a dielectric material and is either inseparable from the device board or made as a separate element.

4. The touch screen control device according to claim 1, wherein the dimensions of the coplanar capacitor plates are selected in such a way that the distance between their geometric centers coincides with the distance between the centers of the touch screen sensors.

5. The touch screen control device according to claim 1, wherein the capacitor plates have connectors with the feedback circuit; the length of the connectors is not more than 2 mm.

6. The touch screen control device according to claim 1, wherein the harmonic oscillator amplifier is assembled in three transistor stages in a common emitter amplifier circuit.

7. The touch screen control device according to claim 1, wherein the harmonic oscillator amplifier is built according to a non-inverting configuration with a zero phase shift at the frequency of excitation autogeneration in the feedback circuit.

8. The touch screen control device according to claim 1, wherein the harmonic oscillator amplifier is inverted at the frequency of excitation autogeneration with a 180-degree phase shift feedback circuit.

9. The touch screen control device according to claim 1, wherein the harmonic oscillator amplifier is inverted, but with a 180-degree phase shift feedback circuit at the frequency of excitation autogeneration and a zero phase shift, or a 360-degree phase shift when combined with the shift of the amplifier multiple times.

10. A method to control the touch screen using the control device according to claim 1, consisting of the following steps:
the voltage is supplied from the control unit to the generator-amplifier of the control device, forming an electromagnetic field between the plates of the coplanar capacitor located in the same plane;
when harmonic voltage fluctuations occur on the plates of the capacitor located in the same plane, the touch screen is affected by applying the capacitor to the sensors of the touch screen in parallel or perpendicular or in intermediate positions, adjacent or at a distance from the surface of the touch screen, where the variable electromagnetic field formed in the auto-oscillation mode of the amplifier affects the fields formed by the sensors of the touch screen, increasing or decreasing their capacitance depending on the operating mode of the touch screen controller;
the touch screen controller is used to determine the change in the capacitances of the touch screen sensors relative to the pre-established rest level, and touch screen events at a point located inside, or at the minimum distance from, the area of projection on the screen of the capacitor plates are recorded.

11. The method according to claim 10, wherein the touch screen is affected with harmonic voltage fluctuations of medium frequency (1-2 MHz) on the plates of the capacitor located in the same plane.

12. The method according to claim 10, wherein the touch screen is affected by applying the capacitor to the sensors of the touch screen at a distance not exceeding 1 mm from the surface of the screen.

13. The method according to claim 10, wherein the coordinates of the touch event registration points are located within an area with a radius of 10 mm, with the center lying within the projection of the coplanar capacitor.

14. The method according to claim 10, wherein the dimensions of the plates of the coplanar capacitor are selected in such a way that the distance between their geometric centers coincides with the distance between the centers of the screen sensors.
